(19) United States
(12) Patent Application Publication
(10) Pub. No.: US 2014/0183281 A1
(43) Pub. Date: Jul. 3, 2014

(54) COLLAR DISTRIBUTOR FOR USE IN DISTRIBUTING A FLUID

(71) Applicant: UOP LLC, Des Plaines, IL (US)

(72) Inventors: Hadjira Iddir, Hoffman Estates, IL (US); Robert Sanger, Mount Prospect, IL (US); Robert T. Sprague, Crystal Lake, IL (US); Franz-Marcus Nowak, Arlington Heights, IL (US)

(73) Assignee: UOP LLC, Des Plaines, IL (US)

(21) Appl. No.: 13/731,365

(22) Filed: Dec. 31, 2012

(51) Int. Cl. B05B 7/00

(52) U.S. Cl. CPC B05B 7/00
USPC 239/398

(57) ABSTRACT

A fluid distribution apparatus includes a distributor pipe configured to carry a fluid and a continuously tapered, ring-shaped collar distributor connected to the distributor pipe. The collar distributor includes a first portion and a second portion, the first portion having a continuous height along its circumference, the continuous height being at least as high as a diameter of the distributor pipe, the second portion extending from either end of the first portion and having a height that continuously tapers along its circumference from a height that is equivalent to the height of the first portion to a second height that is smaller than the height of the first portion. The distributor pipe connects to the collar distributor at the first portion. The apparatus further includes a plurality of inlet nozzles connected to the collar distributor. The second height is at least as great as a diameter of one the plurality of inlet nozzles.

### TECHNICAL FIELD

The present disclosure relates to a device for mixing and distributing a fluid uniformly over the cross-section of an adsorbent bed. The device resides between two adsorbent beds where the effluent from an upper bed is collected and mixed with a feed fluid and redistributed over the top of the lower bed.

### BACKGROUND

The chemical and petroleum process industries use many types of vessels in processing and/or purifying chemicals. The processing and/or purifying often involves mixing fluids and passing a mixture of the fluids over an adsorption bed, a reactor bed, or passing the fluids over trays in a distillation column. One particular type of vessel is a multi-bed reactor, with co-current flow of a process fluid and a feed fluid. The multi-bed reactor includes a series of solid particulate beds of catalyst particles that catalyze a reaction involving a process fluid flowing over the beds. The efficiency and life of the catalyst bed are influenced by the distribution of fluid flowing over the bed. The feed fluid can be added as a reactant, or as a quench fluid, for a process stream that flows over a catalyst bed. Redistribution and mixing is important for maximizing the life of the catalyst bed, and maximum utilization of the catalyst by preventing dead zones, or zones in the catalyst bed having low flow.

Other types of vessels include counter-current flow reactors, separation vessels having co-current flow, or countercurrent flow. Many of these processes are affected by the manner in which a fluid to be reacted, separated, or otherwise processed, is distributed in the vessel.

One important type of process is the adsorption separation process. The adsorption separation process has been developed through simulated moving bed (SMB) technology, where the adsorption separation process can be operated on a continuous basis. The simulation of a moving adsorbent bed is described in U.S. Pat. No. 2,985,589 (Broughton et al.). In accomplishing this simulation, it is necessary to connect a feed stream to a series of beds in sequence, first to bed no. 1, then to bed no. 2, and so forth for numerous beds, the number of beds often being between 12 and 24. These beds may be considered to be portions of a single large bed whose movement is simulated. Each time the feed stream destination is changed, it is also necessary to change the destinations (or origins) of at least three other streams, which may be streams entering the beds, such as the feed stream, or leaving the beds. The moving bed simulation may be simply described as dividing the bed into series of fixed beds and moving the points of introducing and withdrawing liquid streams past the series of fixed beds instead of moving the beds past the introduction and withdrawal points.

There are many different process requirements in moving bed simulation processes, resulting in different flow schemes. For example, in addition to the four basic streams described in Broughton (U.S. Pat. No. 2,985,589), it may be desirable to utilize one or more streams to purge, or flush, a pipeline or pipelines. A flush stream is used to prevent undesirable mixing of components. The flush substance is chosen to be one which is not undesirable for mixing with either main stream, that being purged or that which enters the pipeline after flushing is completed. U.S. Pat. No. 3,201,491 (Stine et al.) may be consulted for information on flushing lines as applied to the process of Broughton (U.S. Pat. No. 2,985,589). In addition, the efficiency of the process has many factors, including the redistribution of fluid from one bed to the next, and the mixing and redistribution of a process fluid with one of the feed streams between two beds.

Improvements in the fluid distribution means of such adsorption separation systems can improve efficiency and increase the life of the adsorbents in the adsorption separation system. Accordingly, it would be an advance in the state of the art to provide a fluid distribution system that is capable of mixing and distributing a fluid uniformly over the cross-section of an adsorbent bed. Furthermore, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

The present disclosure provides embodiments of a fluid distribution apparatus. In one embodiment, an exemplary fluid distribution apparatus includes a distributor pipe configured to carry a fluid and a continuously tapered, ring-shaped collar distributor connected to the distributor pipe. The collar distributor includes a first portion and a second portion, the first portion having a continuous height along its circumference, the continuous height being at least as high as a diameter of the distributor pipe, the second portion extending from either end of the first portion and having a height that continuously tapers along its circumference from a height that is equivalent to the height of the first portion to a second height that is smaller than the height of the first portion. The distributor pipe connects to the collar distributor at the first portion. The apparatus further includes a plurality of inlet nozzles connected to the collar distributor. The second height is at least as great as a diameter of one the plurality of inlet nozzles.

In another embodiment, an exemplary fluid distribution apparatus includes a distributor pipe configured to carry a fluid and a ring-shaped collar distributor connected to the distributor pipe. The collar distributor includes a first portion and a second portion, the first portion having a continuous height along its circumference, the continuous height being at least as high as a diameter of the distributor pipe, the second portion extending from either end of the first portion and having a height that is reduced along its circumference from a height that is equivalent to the height of the first portion to a second height that is smaller than the height of the first portion. The distributor pipe connects to the collar distributor at the first portion. The apparatus further includes a plurality of inlet nozzles connected to the collar distributor. The second height is at least as great as a diameter of one the plurality of inlet nozzles. Each of the plurality of inlet nozzles includes a reducer portion that is proximate to a connection point between the collar distributor and each such inlet nozzle.

In yet another embodiment, an exemplary fluid distribution apparatus includes a distributor pipe configured to carry a fluid and a continuously tapered, ring-shaped collar distributor connected to the distributor pipe. The collar distributor includes a first portion and a second portion, the first portion having a continuous height along its circumference, the continuous height being at least as high as a diameter of the distributor pipe, the second portion extending from either end of the first portion, the second portion including an inlet section and an outlet section, the inlet section including a concave up or upward sloping shape and the outlet section including a concave down or downward sloping shape. The second portion has a height that is reduced along its circumference from a height that is equivalent to the height of the first portion to a second height that is smaller than the height of the first portion. The distributor pipe connects to the collar distributor at the first portion. The apparatus further includes a plurality of inlet nozzles connected to the collar distributor. The second height is at least as great as a diameter of one the plurality of inlet nozzles.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The collar distributor and its associated assemblies will hereinafter be described in conjunction with the following drawing figures, wherein like numerals denote like elements, and wherein:

FIG. 1 is a schematic view of a known flow redistribution apparatus oriented about a central feed pipe within a cylindrical vessel;

FIG. 2 is a side cross-sectional view of a portion of the flow redistribution apparatus of FIG. 1;

FIG. 3 is a side cross-sectional view of an alternative flow redistribution apparatus known in the art;

FIG. 4 is a collar distributor design previously known in the art;

FIG. 5 is a computational fluid dynamics illustration of the flow within a previously known collar distributor as in FIG. 4;

FIG. 6 is an exemplary collar distributor design in accordance with an embodiment of the present disclosure;

FIG. 7 is a computational fluid dynamics illustration of the flow within a collar distributor as in FIG. 6;

FIG. 8 is a perspective view of the collar distributor shown in FIG. 6;

FIG. 9 is an illustration of a collar distributor as in FIG. 6 in an “unrolled” configuration;

FIG. 10 is a cross-sectional view of the collar distributor shown in FIG. 6;

FIGS. 11 and 12 are plots produced using computational fluid dynamics that show improved flow characteristics within a collar distributor as in FIG. 6 compared with known collar distributors as in FIG. 4; and

FIG. 13 is an exemplary collar distributor design in accordance with another embodiment of the present disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. Furthermore, as used herein, numerical ordinals such as “first,” “second,” “third,” etc., such as first, second, and third components, simply denote different singles of a plurality unless specifically defined by language in the appended claims. All of the embodiments and implementations of the collar distributors described herein are exemplary embodiments provided to enable persons skilled in the art to make or use the invention and not to limit the scope of the invention, which is defined by the claims. Furthermore, there is no intention to be bound by any expressed or implied theory presented in the preceding technical field, background, brief summary, or the following detailed description.

A wide variety of processes use co-current flow reactors, or reactors where there is a single phase fluid that flows over a solid bed of particulate materials, to provide for contact between the fluid and a solid. In an adsorption separation system, the solid usually includes an adsorbent material which preferentially adsorbs one or more components in a mixture. The adsorbed material is then removed from the adsorbent by passing a desorbent over the solid bed, and the desorbed component or components are collected. The fluid can be a liquid, vapor, or mixture of liquid and vapor.

Co-current adsorbers with fixed beds are constructed such that the reactor allows for the fluid to flow over the adsorbent bed. When the fluid is a liquid, the fluid is usually directed to flow downward through the adsorber. There are many aspects for providing good contact between the fluid and the solid. Multi-bed adsorbers are also frequently used where the adsorbent beds are stacked one over the other within an adsorbent vessel. Typically, they are stacked with some space between the beds.

With multi-bed adsorbers, the spaces between beds are convenient mixing zones. In addition to remixing fluids passing from one bed to the next, the spaces between beds are often used to add additional fluids, or to draw off fluids. This is particularly true for a simulated moving bed system, where the system has two feed streams and two draw-off streams. The feed streams are the process stream containing components to be separated and a desorbent stream, and the two draw-off streams are the extract stream containing the components that were preferentially adsorbed and a raffinate stream containing the components that were not preferentially adsorbed.

Apparatus for the distribution of a fluid in a vessel previously known in the art include a distribution means with a toroidal, or ring, shaped device with a rectangular cross-section, or box shape. This “distributor box” is connected to a feed pipe with a solid splash plate at the bottom of the box and outlet holes on the sides of the box. A feed stream enters the box through an inlet feed pipe and flows out through the holes on the sides of the box. The feed pipe may be connected to a distributor collar, the distributor collar being configured to deliver the fluid to a plurality of feed pipes. The distributor collar, in turn, is connected to a single distributor pipe that supplies the fluid to the distributor collar. The distributor box is in a mixing zone between adsorbent beds. The process stream enters the mixing zone wherein a baffle directs the process stream toward the distributor box and the process stream and mixes with the feed stream.

The distributor box has a series of holes above the baffle, and a series of holes below the baffle. The process stream impinges on the distributor box as it passes from above the baffle to below the baffle, and mixes with the feed exiting the holes above the baffle in a counter-current flow mixing and mixes with the feed exiting the holes below the baffle in a co-current flow mixing. The resulting mixture is then redistributed on the screen below the baffle. The splash plate is designed to prevent any jet flow introduced from the gap between the baffle and the distributor box, which reduces the risk of localized fluidization of a particulate bed that can cause fine particle generation.

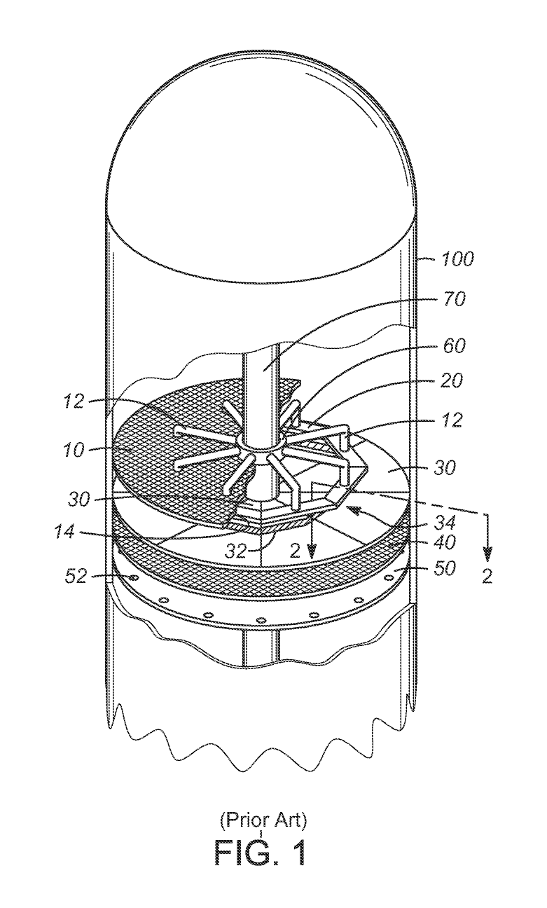

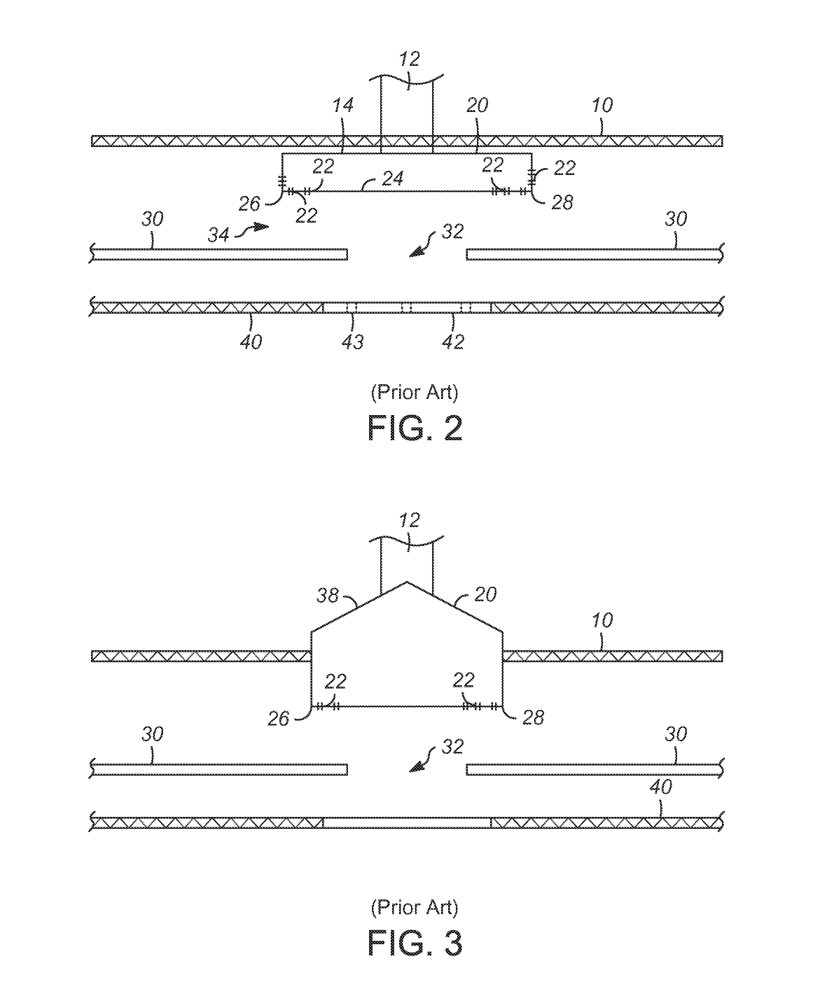

A design previously known in the art, as outlined above, is described in connection with FIG. 1. As shown in FIG. 1, the apparatus includes an upper screen 10 having apertures distributed therein, a distributor box 20 having an inlet 12 and a plurality of fluid outlets 22 (shown in FIGS. 2 and 3) wherein a portion of the distributor box is suspended below the upper screen 10, at least one baffle 30 disposed beneath a portion of the distributor box 20, and a lower screen 40 disposed beneath the at least one baffle 30 and having apertures distributed therein. The baffles 30 form a gap 32 for a mixture of the feed and process fluid to pass to the lower screen 40. The lower screen 40 includes a splash plate 42 (shown in FIG. 2) disposed beneath the gap 32 formed by the baffles 30. In FIG. 1, the distributor box 20 is disposed beneath the upper screen 10, such that there is a gap 14 between the upper screen 10 and the distributor box 20. This gap provides space for the process fluid from the bed above the distribution apparatus to flow around the distributor box 20.

The splash plate 42 can include apertures for allowing some of the mixture to pass through to the adsorbent bed below the lower screen 40. The percent open area of the splash plate 42 from the apertures is less than the percent open area of the lower screen 40. The apertures in the splash plate 42 are sized smaller than the apertures in the lower screen 40. The smaller open area, or smaller apertures, facilitates the distribution of the fluid mixture across the lower screen 40 for a more uniform passage through to the bed below the lower screen 40, while permitting a portion of the fluid mixture to pass through the splash plate 42. The apertures in the lower screen 40 and the splash plate 40 are sized to be sufficiently small to prevent the passage of adsorbent particles from below the apparatus.

The previously known design for the distributor box 20 is a toroidal shape, as noted above and as illustrated in FIG. 1, having a rectangular cross-section, and where the upper 10 and lower 40 screens have a generally circular configuration. The apparatus is disposed within a cylindrical vessel 100, where the apparatus is positioned between beds of solid particles. The distributor box 20 is positioned wherein the center of the cross-section is between about 50% and about 80% of the distance from the center of the upper screen 10 to the outer edge of the upper screen 10. The distance from the center to the outer edge is the radius of the screen 10. The center of the cross-section is positioned between about 70% and about 72% of the distance between the center of the upper screen 10 and the outer edge of the upper screen 10.

The apparatus can, optionally, further include a flow distributor plate 50 as best seen with reference to FIG. 1 positioned beneath the lower screen 40 and placed on top of the adsorbent bed. The flow distributor plate can further even the flow, and can contribute to restricting adsorbent movement at the top of the bed, where the flow distributor plate has apertures 52 sized sufficiently small to prevent to passage of adsorbent through the flow distributor plate. This design incorporates larger apertures in the lower screen 40 and the splash plate 42, as the adsorbent is restricted from passing through the flow distributor plate.

The flow of the process fluid passes through the upper screen 10 and a first portion passes through the central part of the screen 10 that is located within the inner edge of the distributor box 20, and a second portion passes through the screen that is located between the outer edge of the distributor box 20 and the outer edge of the screen 10. The first portion and second portion are in substantially equal amounts to provide a balanced flow across the gaps 34 between the distributor box 20 and the baffles 30. This leads to the center of the distributor box 20 cross-section being positions at approximately 0.707 times radius of the upper screen 10.

The apparatus includes a plurality of inlets 12 for a more even distribution of the feed stream. Each of the plurality of inlets 12 is connected to a ring-shaped distributor collar 60. The distributor collar 60 receives a fluid flow from a single distributor pipe (not shown). The distributor collar 60 distributes the fluid flow from the distributor pipe to each of the inlets 12. The distributor collar is disposed around a centerpipe 70 of the vessel 100.

The upper screen 10 includes a region over the distributor box 20 where there is little or no flow across the screen 10 due to the distributor box 20 blocking that region. The upper screen can include a solid piece of material in that location, or a portion of the distributor box 20 can protrude above the screen 10. The upper portion of the distributor box 20 can be shaped to facilitate flow around the distributor box 20, such as a triangular shape for fluid to direct the process stream around the distributor box 20.

The apparatus includes the upper screen 10, which is fitted around the distributor box 20, baffles 30 which are positioned beneath the outlet ports 22 of the distributor box 20. The gap 32 can be sized to maintain a maximum flow of the mixture of the process stream and feed stream through the gap 32. The distributor box 20 can be designed to have a substantial aspect ratio of width to height, in order to maintain the outlet ports 22 positioned above the baffles 30 and to enable control in the sizing of the gap 32. The aspect ratio also can be used to maintain the flow conditions for the feed stream, while minimizing the overall height of the apparatus, or the upper screen 10, the distributor box 20, the baffles 30, and the lower screen 40.

Two known distributor box 20 designs will now be described briefly with regard to FIGS. 2 and 3. In FIG. 2, the distributor box 20 has a bottom plane 24 and the fluid outlets 22 are holes distributed over the bottom plane 24 toward the edges 26, 28 of the plane 24. The baffles 30 are positioned beneath the fluid outlets 22 and the process fluid flows across the gap 34 between the baffles 30 and the distributor box 20. The baffles 30 overlap the fluid outlet ports 22 to provide good mixing. This is achieved with at least a 20 mm spacing from the outlet ports 22 to the edge of the baffles 30. The feed fluid mixes with the process fluid in a cross flow mixing environment, and the subsequent mixture passes through the baffle gap 32 to the lower screen 40. The baffle gap 32 can be sized sufficiently large to prevent fluid jetting onto the splash plate 42, and the width of the splash plate 42 is preferably greater than the width of the baffle gap 32.

In FIG. 3, the distributor box 20 is disposed partially below the upper screen 10. The top 38 of the distributor box 20 can be flat, or shaped to facilitate flow of process fluid in the bed above the upper screen 10 toward the edges of the distributor box 20. In FIG. 3, the shape is presented as “peaked.”

For an apparatus including the distributor box design of either FIG. 2 or FIG. 3, the apparatus includes a plurality of substantially wedge shaped sections, where there are anywhere from 8 to 40 sections. Typically, there are between 20 and 30 sections and more typically between 24 and 28 sections. Thus, the distributor box is a collection of trapezoidally shaped boxes when viewed from above, such that when fitted together form a polygonal shaped figure that approximates a toroidal shape. The wedge shaped sections include side flanges for attaching sections together, and for providing structural rigidity to the apparatus. The side flanges can be solid, or include openings to allow cross-flow between sections during operation.

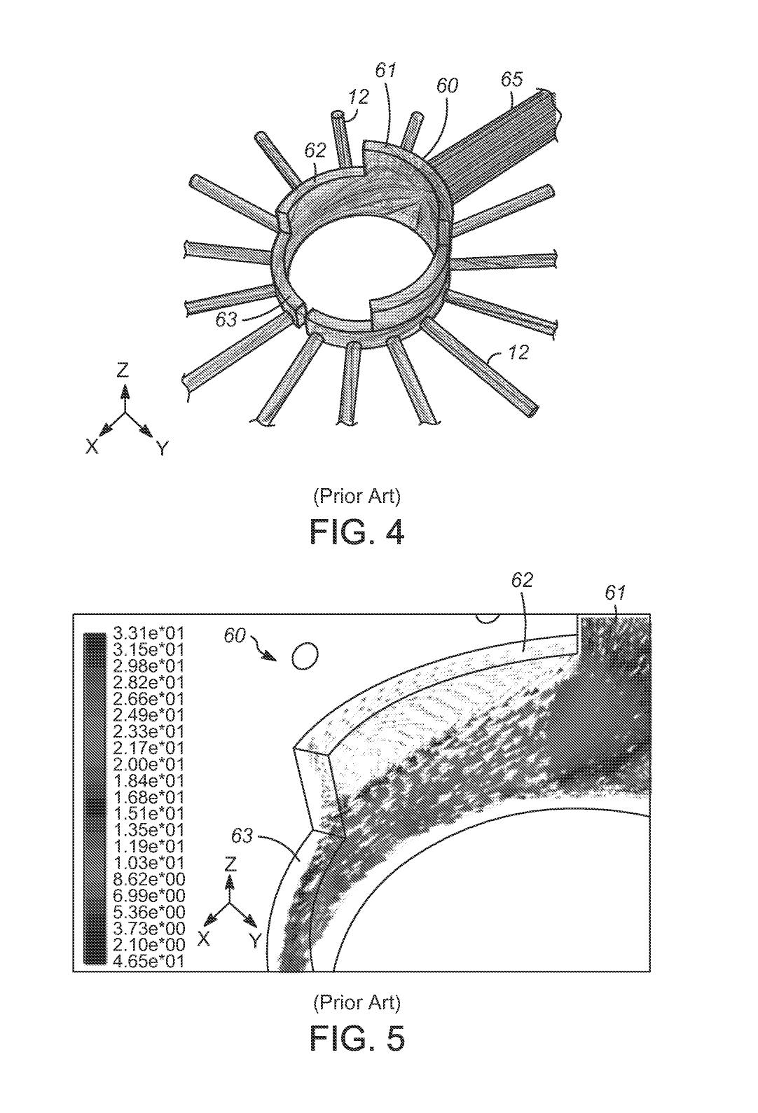

Greater detail regarding the design of a previously known collar distributor 60 is presented with regard to FIG. 4. The previously known collar distributor 60 design includes a “stepped” configuration. The collar distributor 60 includes a first step 61 that is proximate to the connection point with the distributor pipe 65, which delivers the fluid to the collar distributor 60. Upon entering the collar distributor 60, the fluid is initially in step 61. The collar distributor 60 then reduces in height to step 62. Fluid flows from step 61 to step 62. Further, the collar distributor 60 then reduces in height to step 63. Fluid flows from step 62 to step 63. Each of steps 61, 62, and 63 includes one or more inlet pipes 12 connected therewith. Fluid flows from each of the steps 61, 62, and 63 into each of the inlet pipes 12.

In some vessel designs, a significant pressure drop within the chamber has been observed, limiting their operation. The possible cause of this pressure build up is that high fluid velocities within the chamber cause adsorbent movement and corresponding attrition, which leads to accumulation of fine particles that collect on the grids. Local high velocities are typically observed on the top of the adsorbent bed, around the splash plate, and under the side lower screen. Grids are designed to account for these high local velocities, however, it is assumed that there is equal flow to each of the typical 28 baffle sections.

Previous computational fluid dynamics (CFD) experimentation in some designs has shown that some collar distributors have a maldistribution to the typical 14 nozzles (1 nozzle feeds 2 grid sections) up to 20% higher than the designed flow. These high flows will increase the surface velocity and promote movement of the adsorbent on the bed surface. The cause of flow maldistribution to the nozzles is the collar distributor's “stepped” configuration, as described above with regard to FIG. 4. The steps in the collar contribute to loss of flow due to recirculation or back-mixing near the steps. In addition, back-mixing causes a broader residence time distribution (RTD) and higher liquid dispersion which has been shown to reduce performance.

The stepped collar distributor design was tested using theoretical modeling of the flows using computational fluid dynamics. A computational simulation of the process is shown in FIG. 5. Significant recirculation or back-mixing is shown to occur near the forward ends of each step. In particular, as shown in FIG. 5, the flow streams indicate a smooth, forward flow in the lower portion of step 62, but a recirculating flow in the forward, upper portion of step 62. The back-mixing at the top of the steps creates high tangential momentum in the collar such that some of the nozzles receive less flow than the design flow target. Further, this back-mixing causes a broader calculated RTD and higher liquid dispersion which reduces overall performance of the vessel.

Embodiments of the present disclosure are directed to an improved collar distributor that does not suffer the recirculation and back-mixing encountered in other designs. In the presently described embodiments, certain design modifications to the collar distributor ring and the inlet nozzle shown in FIG. 4 are provided. Particularly, this disclosure utilizes a continuously tapered design as opposed to the “stepped” configuration design noted herein, which will improve distribution of fluid to the baffles and reduce back-mixing and pressure drop. To further decrease the overall pressure drop, pipes with reducers are provided as opposed to the straight inlet pipe nozzles shown in FIG. 4.

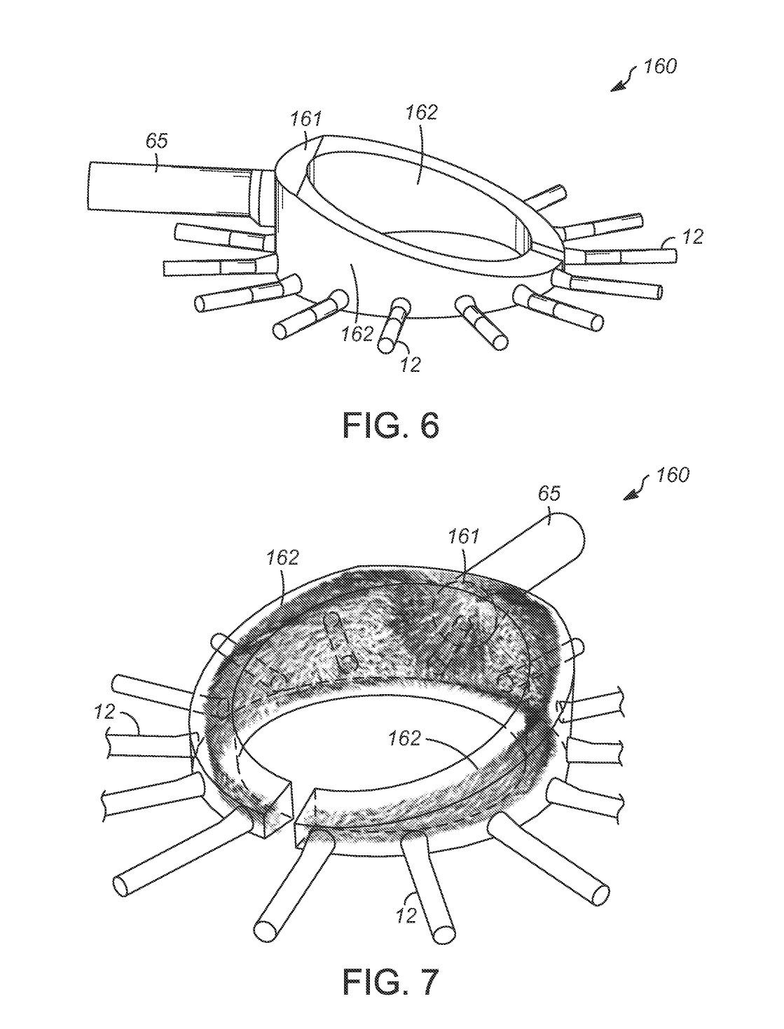

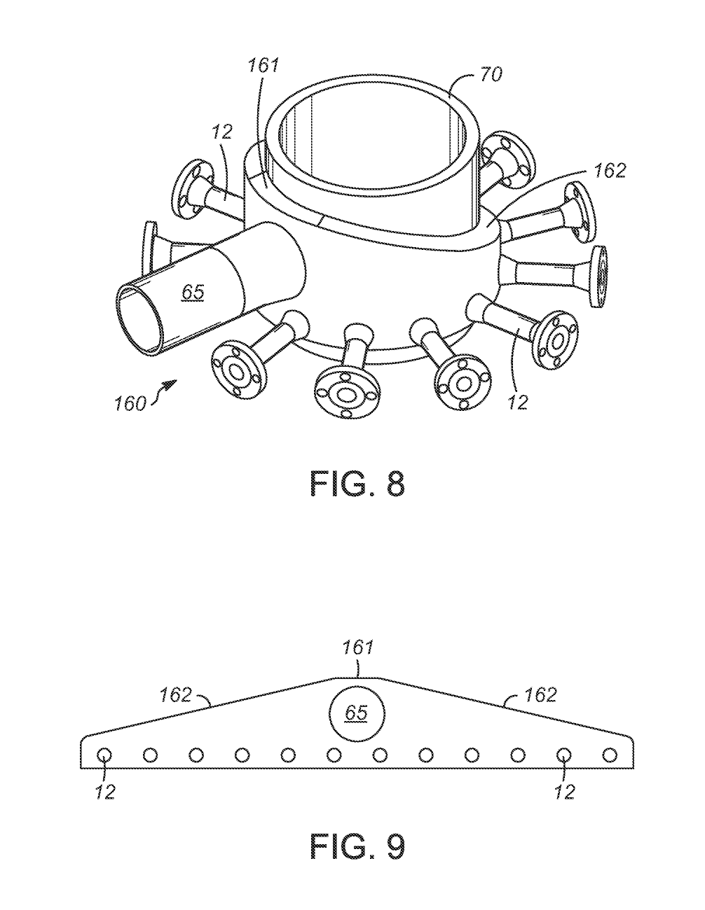

The continuously tapered collar distributor design 160 of the present disclosure is shown, in an exemplary embodiment, in FIGS. 6-10. As shown in FIGS. 6 and 8, the distributor collar 160 includes a first portion 161 that has a constant height along its circumference. The first portion 161 is positioned proximate the distributor pipe 65, and is provided at a constant height so as to accommodate the full diameter of the distributor pipe 65. Forward (flow-wise) from the first portion 161, a second, tapered portion 162 extends from either end of the first portion. The second, tapered portion 162 includes a continuous decrease in height along its circumference, from a height that corresponds to the height of the first portion 161, at the connection points between the first portion 161 and the second portion 162, to a height that is at least as large as the diameter of the inlet nozzles 12, at the end of the distributor collar 160 that is diametrically opposite the distributor pipe 65. The two sides of the second, tapered portion 162 do not need to connect with each other at the end diametrically opposite the distributor pipe 65, but rather there may be a small gap in between closed ends thereof.

FIG. 7 shows theoretical modeling of the fluid flows using CFD for the design shown in FIG. 6. As shown therein, loss of flow due to recirculation or back-mixing is substantially avoided. Rather, the fluid flow appears to be substantially continuous along the entire circumference of the collar distributor 160. This continuous flow will result in a more even fluid flow distribution to each of the inlet nozzles 12 than encountered in prior art design. As such, the analysis suggests that replacing steps with a continuously tapered design would reduce back-mixing due to the steps and improve the distribution to the nozzles. FIG. 7 shows that the flow is uniformly distributed to the nozzles. The tangential momentum has been reduced, thus letting the fluid reach all the nozzles with approximately the same flow rate.

FIG. 9 depicts the distributor collar 160 as it would appear if it were “unrolled” from a ring shape to a planar shape. In an embodiment, the width of the first portion is at least as great as the width of the distributor pipe 65. In an embodiment, the width of the first portion is at least as great as the width of the distributor pipe 65 plus the width of an inlet pipe 12. The height tapers on each side thereof, in second portion 162, continuously to a height that is at least as large as the diameter of the inlet nozzles 12. In an embodiment, the pipe 65 is provided substantially above the inlet pipes 12, relative to the height of the first portion.

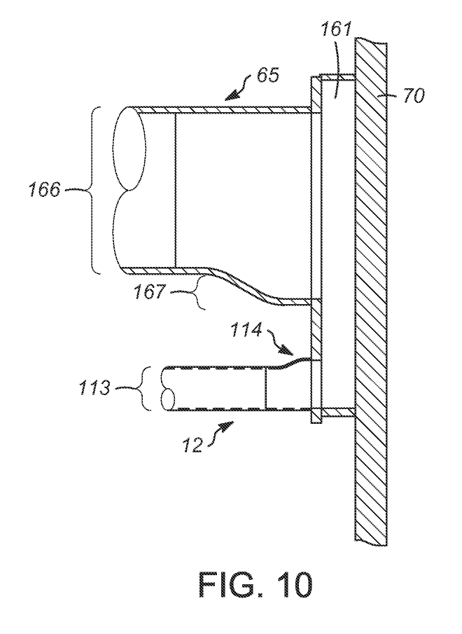

In a further aspect of the present disclosure, it is desirable to minimize the pressure drop in the vessel to reduce loads on the rotary valve. In order to decrease the distributor collar 160 pressure drop, in one embodiment, the distributor pipe 65 and the inlet nozzles 12 are modified from straight pipe configurations to pipes with reducers as shown in FIG. 10. In particular, FIG. 10 shows that distributor pipe 65 includes a straight portion 166 and a reducer portion 167. The reducer portion 167 is an eccentric increase in the diameter of the pipe proximate to the connection with the distributor collar 160. Likewise, each inlet nozzle 12 includes a straight portion 113 and a reducer portion 114. Here as well, the reducer portion 114 is an eccentric increase in the diameter of the inlet nozzle proximate to the connection with the distributor collar 160. Reducers may be provided in a collar distributor design with or without the continuous tapering.

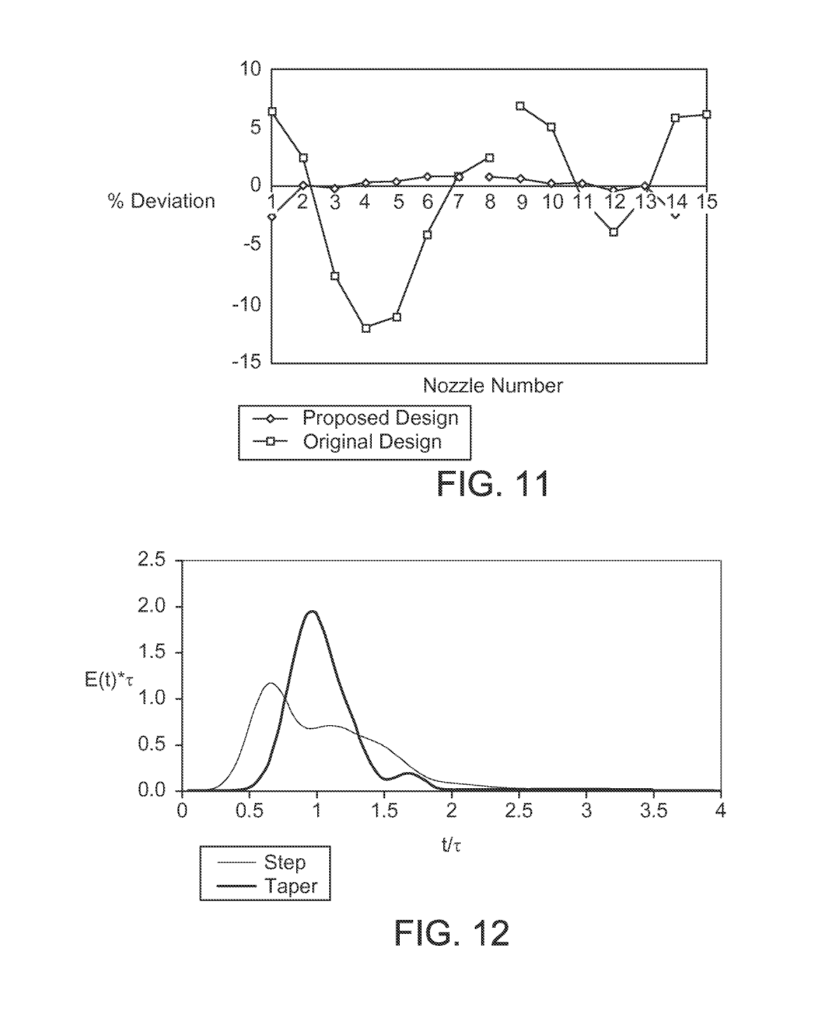

Embodiments of the present disclosure result in a substantially reduced flow deviation. With regard to FIG. 11, a theoretical plot of the flow deviation using CFD is presented from perfect distribution to each nozzle, for both the stepped (“original”; collar with steps) design and the improved design in accordance with present disclosure (“proposed”). The maximum axial velocity deviation from the average flow velocity is shown in FIG. 11 for the two cases. The “original” design creates regions where the axial velocity is relatively high. The local high velocities can lead to fluidization of the adsorbent, which can lead to excess fines and a reduced life of the adsorbent. The results clearly show that the maximum deviation has been reduced from about 14% to about 3%. This indicates a much reduced chance of fluidization of the adsorbent.

In addition, embodiments of the present disclosure show improvement in the RTD. With regard to FIG. 12, a plot is presented showing a comparison between the “stepped” design and the continuously “tapered” design. The plot shows that there is a great improvement in the RTD and thus in the amount of dispersion. For example, in the case shown in FIG. 12, the amount of dispersion deceased by about 75% when using a taper design of the present disclosure.

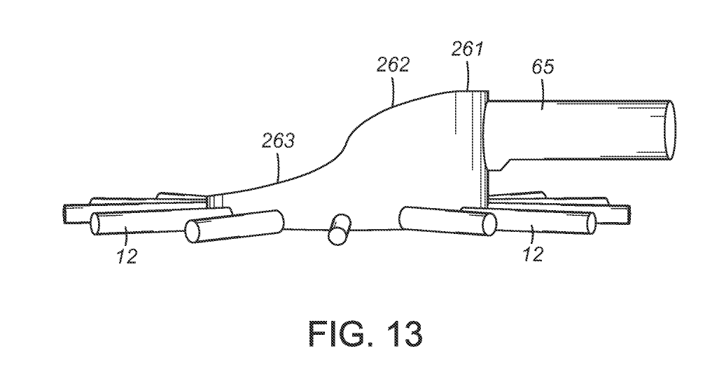

Another embodiment of the present disclosure is depicted with regard to FIG. 13. FIG. 13 discloses a distributor collar 260 with, as in the above examples, a distributor pipe 65 providing feed thereto, and inlet pipes 12 distributing feed therefrom. The distributor collar 260 includes a first portion 261 that has a constant height along its circumference. The first portion 261 is positioned proximate the distributor pipe 65, and is provided at a constant height so as to accommodate the full diameter of the distributor pipe 65. Forward (flow-wise) from the first portion 261, an “inlet” section 262 of the collar is concave up or upward sloping as to minimize pressure. Forward (flow-wise) from the inlet section is an “outlet” section 263 of the collar, which is designed concave down or downward sloping as to maximize the distribution.

To more closely match the flow distribution, variations of this design may be provided. The flow distribution may be determined by experimentation or computational modeling. In an embodiment, the concave up inlet section 262 can be designed so as to be straight, thereby increasing the cross-sectional area (CSA) for the flow. In an embodiment, the concave down outlet section 263 can be a relatively flat section, thereby decreasing the CSA. In an embodiment, the transition zone (the region adjoining sections 262 and 263), in the case of the contoured section, passing through the point of inflection, can be a relatively steep straight section, thereby reducing the CSA. In an exemplary design, the CSA within the Collar is provided so as to match the loss of flow through the outlet.

The design depicted in FIG. 13 may additionally include the reducers, described above, on one or more of the inlet nozzles 12/distributor pipe 65.

Accordingly, embodiments of an improved collar distributor for use in distributing a fluid have been described. It will be appreciated that the described embodiments of the collar distributor change the design of the collar ring from a stepped configuration to a continuously tapered configuration. This design change results in improved fluid flow distribution to the inlet nozzles, therefore reducing the fluid velocity over the adsorbent bed and preventing particle collisions and attrition. The design change further results in an improved RTD and a reduced liquid dispersion, which is expected to improve the vessel performance. It will further be appreciated that the described embodiments of the collar distributor change the design of the inlet nozzles and the distributor pipe from straight pipes to pipes with reducers proximate the collar ring to further decrease the pressure drop, which is expected to minimize the pressure loads on the rotary valve.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the processes without departing from the scope defined by the claims, which includes known equivalents and foreseeable equivalents at the time of this disclosure.

What is claimed is:

1. A fluid distribution apparatus comprising:
a distributor pipe configured to carry a fluid;
a continuously tapered, ring-shaped collar distributor connected to the distributor pipe, wherein the collar distributor comprises a first portion and a second portion, the first portion having a continuous height along its circumference, the continuous height being at least as high as a diameter of the distributor pipe, the second portion extending from either end of the first portion and having a height that continuously tapers along its circumference from a height that is equivalent to the height of the first portion to a second height that is smaller than the height of the first portion, wherein the distributor pipe connects to the collar distributor at the first portion; and
a plurality of inlet nozzles connected to the collar distributor, wherein the second height is at least as great as a diameter of one the plurality of inlet nozzles.

2. The apparatus of claim 1, wherein each of the plurality of inlet nozzles comprises a reducer portion that is proximate to a connection point between the collar distributor and each such inlet nozzle.

3. The apparatus of claim 1, wherein the distributor pipe comprises a reducer portion that is proximate to a connection point between the collar distributor and the distributor pipe.

4. The apparatus of claim 3, wherein the reducer portion is an eccentric increase in the diameter of the pipe.

5. The apparatus of claim 1, wherein the second height is at least as great as the diameter of one of the plurality inlet nozzles plus the diameter of the distributor pipe.

6. The apparatus of claim 1, wherein the ring-shaped collar is discontinuous at an end opposite the connection to the distributor pipe.

7. The apparatus of claim 1 comprising 12 inlet nozzles.

8. A fluid distribution apparatus comprising:
a distributor pipe configured to carry a fluid;
a ring-shaped collar distributor connected to the distributor pipe, wherein the collar distributor comprises a first portion and a second portion, the first portion having a continuous height along its circumference, the continuous height being at least as high as a diameter of the distributor pipe, the second portion extending from either end of the first portion and having a height that is reduced along its circumference from a height that is equivalent to the height of the first portion to a second height that is smaller than the height of the first portion, wherein the distributor pipe connects to the collar distributor at the first portion; and
a plurality of inlet nozzles connected to the collar distributor, wherein the second height is at least as great as a diameter of one the plurality of inlet nozzles, and wherein each of the plurality of inlet nozzles comprises a reducer portion that is proximate to a connection point between the collar distributor and each such inlet nozzle.

9. The apparatus of claim 8, wherein the distributor pipe comprises a reducer portion that is proximate to a connection point between the collar distributor and the distributor pipe.

10. The apparatus of claim 9, wherein the ring-shaped collar distributor is continuously tapered, and wherein the second portion has a height that is continuously tapered along its circumference.

11. The apparatus of claim 9, wherein the reducer portions are eccentric increases in the diameter of the pipe.

12. The apparatus of claim 8, wherein the second height is at least as great as the diameter of one of the plurality inlet nozzles plus the diameter of the distributor pipe.

13. The apparatus of claim 8, wherein the ring-shaped collar is discontinuous at an end opposite the connection to the distributor pipe.

14. The apparatus of claim 8 comprising 12 inlet nozzles.

15. A fluid distribution apparatus comprising:
a distributor pipe configured to carry a fluid;
a continuously tapered, ring-shaped collar distributor connected to the distributor pipe, wherein the collar distributor comprises a first portion and a second portion, the first portion having a continuous height along its circumference, the continuous height being at least as high as a diameter of the distributor pipe, the second portion extending from either end of the first portion, the second portion comprising an inlet section and an outlet section, the inlet section comprising a concave up or upward sloping shape and the outlet section comprising a concave down or downward sloping shape, wherein the second portion has a height that is reduced along its circumference from a height that is equivalent to the height of the first portion to a second height that is smaller than the height of the first portion, and wherein the distributor pipe connects to the collar distributor at the first portion; and
a plurality of inlet nozzles connected to the collar distributor, wherein the second height is at least as great as a diameter of one the plurality of inlet nozzles.

16. The apparatus of claim 15, wherein each of the plurality of inlet nozzles comprises a reducer portion that is proximate to a connection point between the collar distributor and each such inlet nozzle.

17. The apparatus of claim 16, wherein the reducer portion is an eccentric increase in the diameter of the pipe.

18. The apparatus of claim 15, wherein the distributor pipe comprises a reducer portion that is proximate to a connection point between the collar distributor and the distributor pipe.

19. The apparatus of claim 15, wherein the second height is at least as great as the diameter of one of the plurality inlet nozzles plus the diameter of the distributor pipe.

20. The apparatus of claim 15, wherein the ring-shaped collar is discontinuous at an end opposite the connection to the distributor pipe.
